(19) United States
(12) Patent Application Publication
(10) Pub. No.: US 2011/0101667 A1
(43) Pub. Date: May 5, 2011

(54) Giftcard Storybook Method and Apparatus

(76) Inventors: Christopher A. Alizieri, Wake Forest, NC (US); Lesley Alizieri, Wake Forest, NC (US)

(21) Appl. No.: 12/915,698

(22) Filed: Oct. 29, 2010

Related U.S. Application Data
(60) Provisional application No. 61/256,793, filed on Oct. 30, 2009.

(51) Int. Cl. B42D 1/00

(52) U.S. Cl. 281/15.1

(57) ABSTRACT

The teachings presented herein provide a “storybook” for presenting a thematically related set of gift cards, and further provide a method for ordering such storybooks, which may be offered under the trademark GIFTCARD STORYBOOKS. In at least one embodiment, a gift card storybook as contemplated herein comprises a professionally published, pre-written and illustrated book that tells a story and incorporates a series of insertion points for gift cards related to the unfolding storyline.

### RELATED APPLICATIONS

This application claims priority under 35 U.S.C. §119 from the U.S. provisional application filed on 30 Oct. 2009 and assigned Application No. 61/256,793, and which is incorporated herein by reference.

### FIELD OF THE INVENTION

The present invention generally relates to gift cards, and particularly relates to gift card storybooks having a thematic content and arrangement corresponding to gift card insertion points strategically placed within the book.

### BACKGROUND

Gift card popularity has steadily increased in popularity (an average of approximately 28% annually), and we now spend about $97 billion annually gift cards. Convenience for the giver is a key aspect of gift card popularity, but the freedom of the gift card recipient to buy whatever he or she wants (subject to the limitations of the gift card) is another important component of gift card popularity.

However, despite the popularity of gift cards, they are perceived to be less thoughtful or personal gifts, distinguished from cash gifts only by the gift card type or brand. Various approaches attempt to address the impersonal aspects of gift cards given, but these approaches have only limited success. A fairly common approach to dressing up a gift card gift relies on the use of premium packaging for presentation of the gift card. Packaging examples include decorative tins and greeting card like carriers that often provide places for a handwritten note from the giver.

While the use of premium packaging arguably improves the presentation experience, such packaging still offers limited opportunity for thoughtful gift personalization, and it can be expensive, in comparison to conventional greeting card costs. Worse still, perhaps owing to the lack of meaningful personalization, gift card recipients often quickly discard such premium packaging.

### SUMMARY

The teachings presented herein provide a “storybook” for presenting a thematically related set of gift cards, and further provide a method for ordering such storybooks, which may be offered under the trademark GIFTCARD STORYBOOKS. In at least one embodiment, a gift card storybook as contemplated herein comprises a professionally published, pre-written and illustrated book that tells a story and incorporates a series of insertion points for gift cards related to the unfolding storyline.

Gift cards may be purchased in conjunction with selecting and ordering the gift card storybook, or the storybook purchaser may elect to purchase the storybook without gift cards, and add in separately purchased gift cards. In either case, the storybook with its installed set of gift cards takes its recipient through a gifting “journey,” with many opportunities to purchase desired, story-related items along the way.

Among the many notable personalization aspects, the storybook itself will have been selected by its giver to provide the recipient with a rich, multi-faceted gift experience. As non-limiting examples, available storybooks include sports-themed storybooks intended to carry sets of sports-related gift cards and/or outdoor-themed storybooks intended to carry sets of outdoor-related gift cards. Other themes include night-on-the-town stories, and “romantic” anniversary stories.

Gift card storybooks are purchased at retail locations and/or are purchased using an online ordering system, as contemplated herein. The online ordering system provides for the selection of a pre-written, or customizable gift card storybook, and provides the option of selecting and purchasing desired gift cards for inclusion in the gift card storybook. In at least one embodiment, the online ordering system comprises a web server that provides one or more web pages (e.g., HTTP forms-based pages) that display available gift card storybooks and merchant gift cards. Notably, the online ordering system in one or more embodiments uses location information for intended recipient, e.g., zip code, to provide locally relevant gift card options.

With the above in mind, the teachings herein provide a gift card storybook that, in one embodiment, comprises: a number of pages compiled together in a book form, said pages presenting a themed gifting story printed thereon; and a plurality of gift card attachment locations distributed among the pages, at strategic gifting points in the themed gifting story. The gift card storybook in one or more embodiments further includes a set of gift cards, each removably fixed to a corresponding gift card attachment location on a given page of the gift card storybook.

Here, the “corresponding” gift card attachment location is the page/page location where the particular type/brand of gift card logically ties in with the thematic gifting story unfolding across the book pages. For example, in a romantic “night-on-the-town” themed story, the unfolding story may have a section relating to a couple's romantic dinner, and the page(s) relating to that section of the story would have a strategically located gift card attachment location, for a restaurant gift card. In at least one such embodiment, the gift card attaches to page location where the dinner-portion text of the storyline is positioned beside or around the attached card. In other words, each gift card attaches to the corresponding, contextually relevant attachment location as defined by the thematic gifting story.

In one or more embodiments, the attachment locations each comprise one of: an insertion sleeve formed in or on a given one of the pages; an exposable adhesive strip positioned on a given one of the pages (which may be protected by wax paper or other removable cover); or a set of die cuts on a given page, arranged for holding an inserted gift card. In a preferred embodiment of the die cut based attachment locations, each attachment location comprises a set of four die cuts, arrayed in correspondence with the four corners of a typical credit-card sized gift card. The portion of the page underlying the attachment point may include text identifying the type/brand of card to be positioned at that point.

As for the cards themselves, they may be purchased separate from the gift card storybook, or they may be purchased in conjunction with the book. One or more embodiments of the contemplated online ordering process provide a convenient, easy buying experience in either case. For example, one or more web servers are configured to provide a browser-based ordering system using, e.g., HTTP pages including one or more ordering forms, that allows purchasers to select a desired gift card storybook and/or browse through available gift card storybooks, select whether to purchase the gift card storybook with or without included gift cards, specify gift packaging and delivery options, etc.

Further, in embodiments where the online ordering system provides the option of purchasing complete gift card storybooks, including the gift cards themselves, the online ordering system provides users with an opportunity to view/select preferred types of gift cards/gift-card merchants, along with choosing gift values, etc. In at least one such embodiment, the system is configured to display the available gift card choices in logical correspondence to the thematic content of the selected gift card storybook. For example, if the purchaser has selected a hunting- or camping-themed gift card storybook, the system displays gift card selections for various outdoor and hunting equipment vendors, guide services, etc. In particular, the type/set of gift card selections may be dynamically matched for each gift card insertion location of the selected gift card storybook.

Still further, in at least one embodiment, the online ordering system provides for full or partial gift card storybook customization. In a partial custom implementation, the gift card storybook includes one or more textual and/or graphical components that are selectable or customizable by the purchaser—e.g., the gift recipient's name, photo, etc. can be uploaded to the system, or otherwise provided, for incorporation in the printed copy of the gift card storybook. In a full customization, the ordering system allows purchasers to perform one or more of the following: create a custom theme, provide story copy and/or artwork, control page layout and/or gift-card insertion point, select front/back cover book styles, paper type/quality, etc.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a diagram of one embodiment of a gift card storybook.

FIG. 2 is a diagram of one embodiment of a web-based ordering system.

FIG. 3 is a diagram of one embodiment of a online ordering system, such as may be supported by the web-based ordering system of FIG. 2

### DETAILED DESCRIPTION

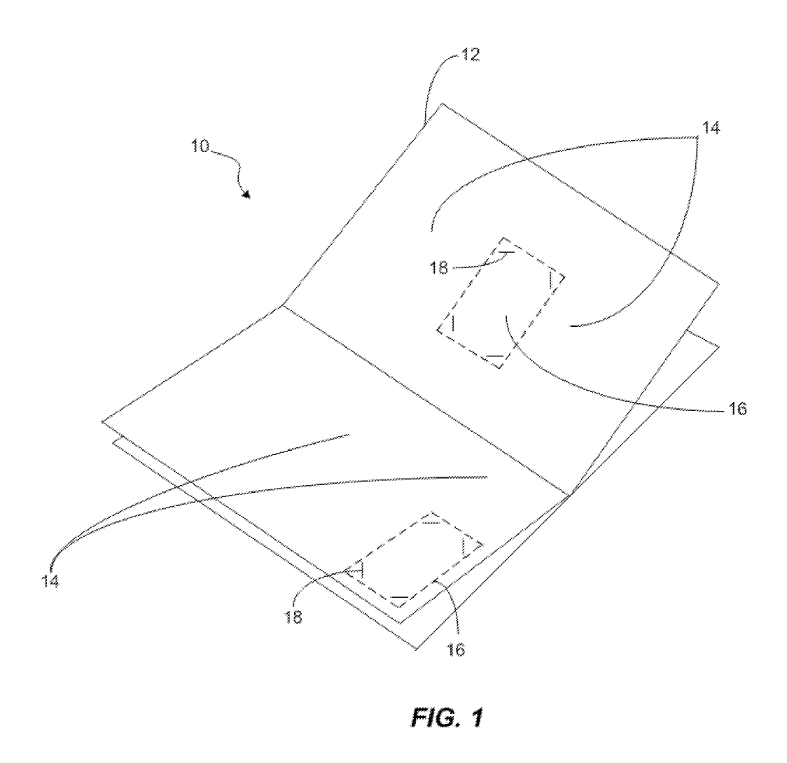

FIG. 1 illustrates one embodiment of a gift card storybook, although it is not necessarily intended to depict a preferred size, or binding and page layout style. Thus, FIG. 1 is understood as a non-limiting example in which one sees an embodiment of a gift card storybook 10 comprising a number of pages 12. A given page 12 includes one or more text areas 14 and one or more gift card attachment locations 16. In one embodiment, the attachment location includes a set of die-cut slits 18 for mounting the card's corners. Other mounting arrangements are contemplated, including insertion sleeves or slots, adhesive-based attachment points, etc.

In at least one embodiment, the gift card storybook is 8.5″×8.5″ and is printed on publisher grade white or colored paper, with a thicker cardstock (paperback) cover. The book length ranges from 5-10 pages and the book is printed in full color and assembled using a saddle-stitch through the book's center in two separate locations on the spine. The gift card storybook includes, in at least one embodiment, several components:
1) Front cover stock, which may carry several trademarks, including the GIFTCARD STORYBOOK logo. Within this globe is the title of the GiftCard Storybook, the text “An Original GiftCard Storybook”, followed by a line labeled “Given To:” and “From:”
2) Inside page of front cover blank;
3) Text and/or illustrations begin the book, with gift card insertion points at various placeholders throughout the storybook. Each page is numbered in the bottom right/left corner of the page. The insertion points are shaded and labeled to advise consumers where to affix their gift cards.

Thus, with the example of FIG. 1 in mind, the present invention in one or more embodiments comprises an apparatus for providing a thematically related set of gift cards. The apparatus comprises a book that includes a number of pages, said pages presenting a themed gifting story printed thereon. In such context, at least some of the book pages each include at least one gift card attachment location positioned on the page in direct relation to a gifting point in said themed gifting story. In this manner, the book provides a plurality of gift card attachment locations distributed among said pages at corresponding gifting points in said themed gifting story.

In at least one such embodiment, each gift card attachment location comprises one of: an insertion sleeve formed in or on the page; an exposable adhesive strip positioned on the page; or a set of die cuts on the page, said set of die cuts arranged for holding an inserted gift card.

Further, in at least one embodiment, a portion of the page underlying the gift card attachment location includes indicia identifying a type or brand of gift card to be attached to the gift card attachment location.

Still further, in at least one embodiment, the apparatus includes the book and a plurality of gift cards, each one of said gift cards corresponding to a respective one of said plurality of gift card attachment locations.

In yet another embodiment, the apparatus comprises a book that comprises a plurality of pages, including a number of gift card attachment locations distributed among said plurality of pages, for carrying a corresponding number of gift cards in correspondence with a themed gifting story conveyed by said book. The gift card attachment location or locations on any given page of said book are physically positioned on the page in direct correspondence with a gifting point or points in said themed gifting story. In this manner, it will be understood that the book is physically configured such that it provides a thematically ordered and positioned set of gift card attachment locations keyed to the themed gifting story presented by the book.

In at least one such embodiment, the portions of the book pages corresponding to the gift card attachment locations are shaded or labeled, to indicate said gift card attachment locations. Further, in at least one such embodiment, the page portion corresponding to each gift card attachment location includes a label or other indicia identifying a type or brand of gift card that is intended to be positioned at the gift card attachment location with respect to the gifting point in the themed gifting story that corresponds to the gift card attachment location.

Further, the storylines and illustrations of the gift card storybooks are tailored to a variety of audiences and occasions, and thus offer a year round gift concept. That is, different gift card storybooks may carry different themed gifting stories, so that consumers can buy (or customize) a gift card storybook with a particular themed gifting story.

Thus, in at least one embodiment, which has a number of marketing advantages, there are a number of gift card storybook themes available, with each one targeted to a different type of intended recipient. As non-limiting examples, there may be a gift card storybook themed for grandparents as the intended recipients, or ones themed for girlfriends, sisters, daughters, pet owners, etc. One advantage of tailoring the storybook theme to a targeted recipient is that the same book suits a variety of occasions. For example, one person may use a “Dad” themed book as a birthday gift, while another selects the same book as a Christmas gift. Additionally, or alternatively, there are gift card storybooks having brand or product-based themes. For example, there may be coffee or food-based theme tied to a particular brand or merchant.

Regardless of the particular thematic approach used, however, in one or more embodiments, the storybooks can be ordered without gift cards or completely fulfilled with activated gift cards ready for use. In the former case, the cards are attached by the consumer utilizing included temporary adhesive glue dots, die cut custom paper, photo corners, or other methods.

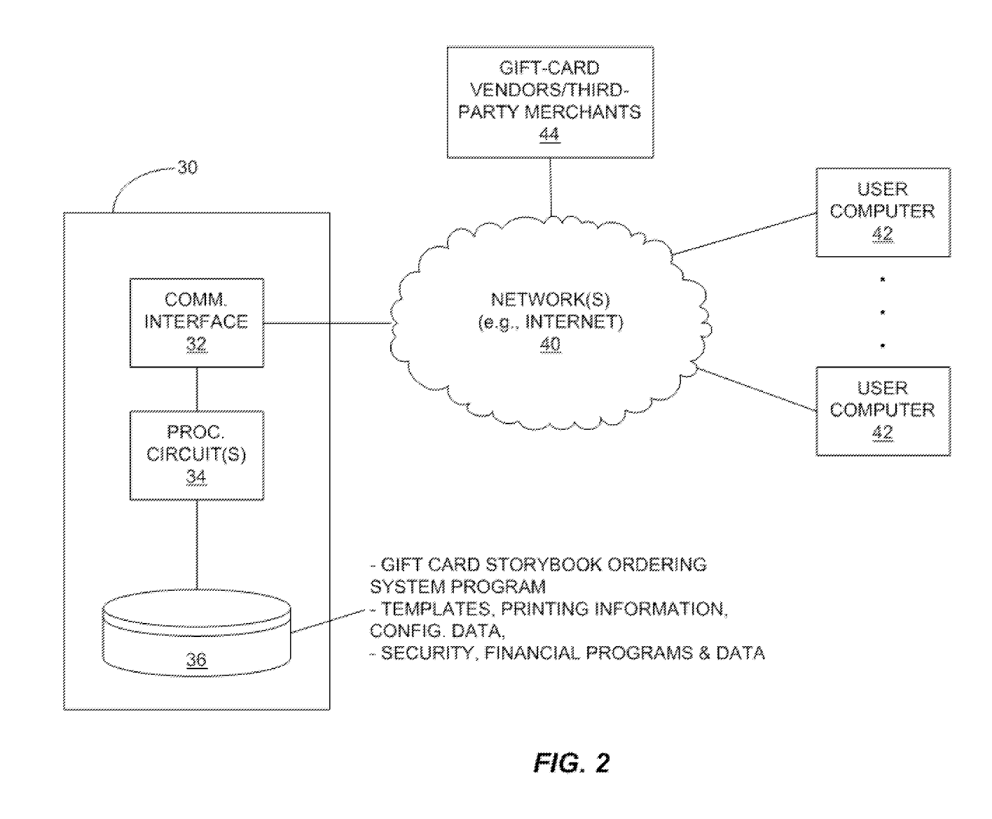

The particular book and/or cards ordered may be conveniently selected by the consumer through an innovative online ordering system and method. FIG. 2 illustrates a non-limiting embodiment of an online ordering system supporting one or more of the online ordering methods contemplated herein. The system includes a web server 30 (or a collection of servers). The sever 30 includes a communication interface 32—e.g., a network interface for web accessibility—and further includes one or more processing circuits 34. As an example, the processing circuit(s) comprise computer-based processing circuits configured to provide an online gift card storybook ordering system, based on the execution of one or more computer programs. The processing circuits therefore may include or otherwise have access to local and/or remote storage systems. For example, a storage system 36 (e.g., disk drive, memory, etc.) stores a gift card storybook ordering system program, which configures the server 30 to act as a web server for ordering gift card storybooks, for example. The storage system 36 may further store storybook templates (page layouts, artwork, etc.), printing information (for use, e.g., by an associated on-demand printing system). The storage system 36 also may include security and financial programs and/or data, including security certificates, etc., as needed for directly or indirectly conducting storybook purchasing transactions, interacting with gift card merchants, etc.

In one or more embodiments, the communication interface 32 comprises one or more network interfaces, which communicatively couple the web server 30 to one or more network(s) 40, e.g., the Internet, for web-based gift card storybook ordering. As such, users at one or more remote user computers 42 may interact with the web server 30, for gift card storybook ordering. For example, the web server 30 provides one or more web pages that enable the users to browse, select, customize, order, and pay for gift card storybooks, and/or the web server 30 may provide downloadable applets, scripts, or the like, for execution on the user computers 42, to support some or all such actions. Note, too, that the web server 30 may interact with one or more gift-card merchants and/or other third-party vendors 44, for book ordering. For example, gift card purchases may be facilitated or otherwise handled by one or more third-party sites or databases.

In any case, the online ordering system provides for significant purchasing flexibility. For example, the gift card storybook can be customized by gender, occasion, specific birthday, et cetera, and have the recipient's name incorporated in the story itself, if the purchaser selects a customized storybook option. Note, too, that the storybook may be enhanced into a longer storyline, photo memory book, and scavenger hunt style gift. Note that any or all of these variations and extensions can be configured to continue with the basic concept of inter-relating the content of the pages to the gift cards attached to those pages.

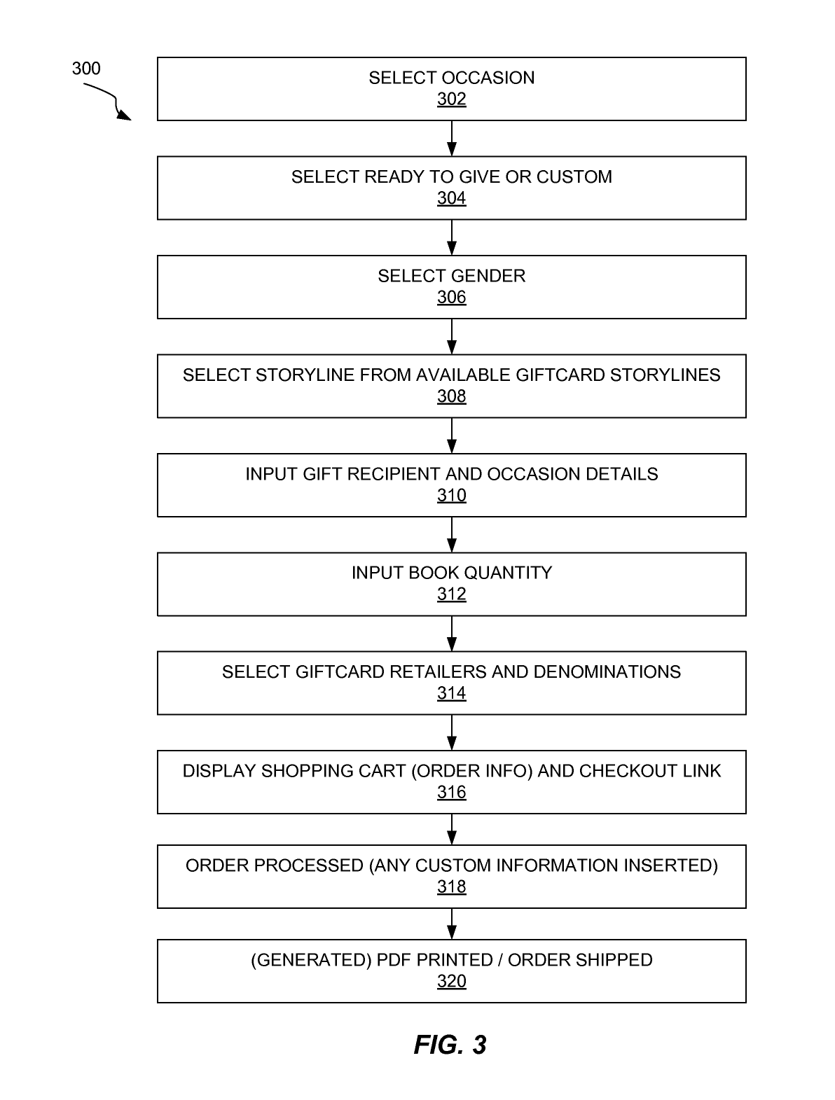

FIG. 3 illustrates one embodiment of a gift card ordering method 300, including operations or steps 302-320 (even). An online website (e.g., GIFTCARDSTORYBOOKS.COM) may provide users with the web pages (forms, applets, etc.) as needed to purchase a gift card storybook, optionally customize it, optionally select gift cards to be included, and arrange for desired delivery.

For example, a first available option is for a pre-developed storyline. Once selecting this product, the customer (user) is led through a selection process. The system queries the user, or otherwise displays a form/selectable control element that allows the user to specify the occasion for which the gift card storybook is being ordered (302).

In response to the occasion information, the system identifies to the user a selection of available storybooks, including “ready to give” and customizable book options (304). In at least one embodiment, the method 300 obtains gender information from the user (306) and uses that to information to recommend storylines, etc. In any case, the method 300 continues with providing the user with a range of available storylines (308), preferably including a brief synopsis of the storyline. The system then monitors for or otherwise receives input from the user (308, 310, 312), indicating the desired book selection, along with ordering quantity, for example.

The system may then further query the user, or otherwise permit the user to select whether gift cards will or will not be purchased in conjunction with the gift card storybook being ordered. If so, the system takes the user through a series of gift card selections (314), corresponding to the individual gift card insertion points for the selected storyline. Note that the system in one or more embodiments allows the user to select whether or not to purchase gift cards per insertion point, meaning that the book may be preloaded with some cards, with other insertion points left blank for the user to add his or her own separately purchased cards.

As noted, the gift card selections presented by the system may be made easier for the user by displaying only those gift card merchants and/or gift card types which appropriately fit a particular story insertion point within the storyline. For example, the system may display categories, such as “Hardware Store,” or “Sporting Goods,” etc. If more than one book is ordered, such processing may be provided and particularized for each book. The ordering page thus provides for the selection of gift card type, retail, gift amount, etc. And the page is configured in one or more embodiments to provide for such selections for multiple books, in instances where the user is purchasing more than one copy of the given storyline. Note, too, that the gift card purchases may not be transacted immediately, but rather may be buffered, for final review and verification by the user.

For example, the ordering system may display to the user a book summary page, showing the set of gift cards to be purchased, along with their individual gift amounts, and an overall total gift amount. The user can replace, delete, or otherwise modify the gift card selections at this point, and then confirm the purchase or backtrack in the purchasing process. In at least one embodiment, the ordering system aggregates the gift card and book purchases together, while in other embodiments, the online ordering system facilitates per-card/per-merchant charge transactions between the user and the card merchants.

The storyline, customization, and card selection options may be presented, for example, using thumbnail icons, drop down menus, pick lists, radio buttons, drag-and-drop screens, etc. Regardless, once the book and its options are finalized, the system places the completed book(s) in a shopping cart, or otherwise makes them available for purchase review and confirmation (316). As part of finalizing the purchase process, the user may select delivery details, providing mailing information, etc. Once any custom information is inserted into the (electronic) book (318), a finalized, a PDF or other electronic file (or files) can be transferred to a printing system (local or remote), for on-demand printing of the user's just-purchased storybook (320).

In at least one embodiment of the online ordering system and method that provides for custom storybooks, the contemplated ordering system (e.g., comprising a web server and associated book data), may query a user for:
Recipient-related information, such as the gift recipient's name and interests (e.g., electronics, video games, sports, etc.);
the type of occasion for which the storybook is intended;

The web application may then take the above information to assemble a storyline by piecing together already written general storylines. It also can insert user-supplied custom information or other data (e.g., photos) at designated insertion points, so that the completed storybook is tailored to the particular occasion and recipient.

Of course, these and other options are not limiting. Therefore, it is to be understood that the present invention(s) is/are not to be limited to the specific embodiments disclosed and that modifications and other embodiments are intended to be included within the scope of this disclosure.

What is claimed is:

1. An apparatus for providing a thematically related set of gift cards comprising:
a book that includes a number of pages, said pages presenting a themed gifting story printed thereon;
wherein at least some of said pages each include at least one gift card attachment location positioned on the page in direct relation to a gifting point in said themed gifting story, such that said book provides a plurality of gift card attachment locations distributed among said pages at corresponding gifting points in said themed gifting story.

2. The apparatus of claim 1, wherein said gift card attachment location comprises one of: an insertion sleeve formed in or on the page; an exposable adhesive strip positioned on the page; or a set of die cuts on the page, said set of die cuts arranged for holding an inserted gift card.

3. The apparatus of claim 1, wherein a portion of the page underlying the gift card attachment location includes indicia identifying a type or brand of gift card to be attached to the gift card attachment location.

4. The apparatus of claim 1, further comprising a plurality of gift cards, each one of said gift cards corresponding to a respective one of said plurality of gift card attachment locations.

5. An apparatus for providing a thematically related set of gift cards comprising:
a book comprising a plurality of pages including a number of gift card attachment locations distributed among said plurality of pages, for carrying a corresponding number of gift cards in correspondence with a themed gifting story conveyed by said book; and
wherein the gift card attachment location or locations on any given page of said book are physically positioned on said page in direct correspondence with a gifting point or points in said themed gifting story, such that said book provides a thematically ordered and positioned set of gift card attachment locations keyed to said themed gifting story.

6. The apparatus of claim 5, wherein portions of said pages corresponding to said gift card attachment locations are shaded or labeled, to indicate said gift card attachment locations.

7. The apparatus of claim 5, wherein a page portion corresponding to each said gift card attachment location includes a label or other indicia identifying a type or brand of gift card that is intended to be positioned at said gift card attachment location with respect to the gifting point in said themed gifting story that corresponds to the gift card attachment location.
